(19) United States
(12) Patent Application Publication
(10) Pub. No.: US 2026/0369083 A1
(43) Pub. Date: Nov. 19, 2026

(54) VISION-BASED EGG CONTENT INSPECTION AND SELECTIVE REJECTION SYSTEM INTEGRATED WITH EGG BREAKING MACHINERY

(71) Applicant: Bear Technology LLC, Birmingham, MI (US)

(72) Inventors: Arun Dalmia, Grand Rapids, MI (US); Roberto Taormina, Clay, MI (US)

(73) Assignee: Bear Technology LLC, Birmingham, MI (US)

(21) Appl. No.: 19/679,817

(22) Filed: May 18, 2026

Related U.S. Application Data
(60) Provisional application No. 63/808,566, filed on May 19, 2025.

(51) Int. Cl. G06V 20/68; A23J 1/08; G06V 10/44; G06V 10/764

(52) U.S. Cl. CPC G06V 20/68; A23J 1/08; G06V 10/443; G06V 10/765

(57) ABSTRACT

A system and method for inspecting egg contents in an egg-breaking machine includes an overhead-mounted vision system configured to capture images of egg contents in transport cups. A processing unit analyzes the images using machine learning algorithms to detect defects and associates inspection results with cup positions. A rejection mechanism selectively removes defective egg contents based on the inspection results. The system operates in real time and may be retrofitted onto existing egg-processing equipment. The system includes AI-enabled machine learning capabilities to better identify defects in egg contents.

### CROSS-REFERENCE TO RELATED APPLICATIONS

This application claims the benefit of U.S. Provisional Patent Application 63/808,566, filed May 19, 2025, the entire contents of which are incorporated herein by reference.

### FIELD OF THE DISCLOSURE

The present disclosure relates generally to automated inspection systems used in food processing environments. More particularly, the disclosure relates to a machine vision system configured to inspect liquid egg contents following shell breakage and to selectively remove defective egg contents in real time while maintaining industrial processing speeds.

### BACKGROUND OF THE DISCLOSURE

Modern egg processing facilities operate at extremely high throughput, with automated egg-breaking machines processing tens of thousands of eggs per hour. In such systems, eggs are mechanically cracked, and their contents are deposited into individual cups or carriers that travel along a conveyor system. While pre-break inspection techniques exist for evaluating shell integrity or external contamination, many defects are only detectable after the egg has been broken.

Such post-break defects include, for example, blood spots, meat spots, shell fragments, microbial contamination, abnormal coloration, yolk rupture, and foreign materials. Conventional detection of these defects relies heavily on human operators who visually inspect egg contents. However, manual inspection is inherently inconsistent, labor-intensive, and insufficient for modern high-speed processing environments.

Existing inspection systems, including those configured to detect debris on conveyors, typically operate on intact eggs or bulk food streams and do not provide precise, per-container inspection and rejection capabilities for liquid egg contents immediately after breakage. Moreover, many such systems are not designed to integrate as modular add-ons to existing egg-breaking machines without significant modification.

Accordingly, there exists a need for a system that can be installed on existing egg-breaking machinery, that performs real-time inspection of egg contents after breakage, that reliably detects defects using advanced image analysis techniques, and that selectively removes defective egg contents without interrupting production throughput.

### SUMMARY OF THE DISCLOSURE

The present disclosure provides a retrofit, overhead-mounted inspection system configured for integration with an existing egg-breaking machine having a conveyor transporting individual egg contents in discrete cups arranged in multiple parallel lanes. The system captures images of each cup at a fixed position using encoder-synchronized triggering, analyzes the images in real time using a processor executing a trained machine learning model, and generates a pass/fail determination for each cup.

Inspection results are stored in a position-indexed data structure that maintains a deterministic association between each result and a corresponding cup position as the conveyor advances. A rejection mechanism located at a position is actuated based on the stored result to selectively discharge defective egg contents without interrupting conveyor motion.

In preferred embodiments, the system operates across multiple lanes simultaneously, employs multispectral illumination to enhance defect contrast, and utilizes a hybrid decision framework combining machine learning outputs with rule-based validation. The system further supports continuous model improvement through data logging, labeling, retraining, and redeployment, including enterprise-level aggregation across multiple installations.

The disclosure also encompasses corresponding methods of inspecting egg contents and controlling rejection using encoder-indexed tracking, as well as non-transitory computer-readable media storing instructions that implement such inspection and control.

The present disclosure addresses the foregoing needs by providing a modular inspection system configured to be mounted above an existing egg-breaking machine. The system includes an imaging assembly, an illumination system, a processing unit, and a rejection mechanism, all coordinated to inspect individual egg contents in transport cups and selectively remove defective contents.

In operation, eggs are cracked by the underlying egg-breaking machine, and the contents of each egg are deposited into individual cups that are transported along a conveyor. The inspection system is positioned above the conveyor and captures images of the egg contents within each cup. These images are processed in real time using a combination of computer vision techniques and machine learning algorithms to detect defects. Each inspection result is associated with a specific cup position, and a rejection mechanism is actuated to remove defective egg contents from the conveyor.

The system may further incorporate artificial intelligence models that are trained using labeled datasets of egg content images. These models may be continuously improved through data collection and retraining, thereby enhancing defect detection accuracy over time. The system is designed to operate within the timing constraints of the conveyor system and to integrate seamlessly with existing equipment without requiring modification of the base egg-breaking machine. The system further includes data logging and feedback mechanisms that enable continuous improvement of the machine learning models over time.

The system is capable of inspecting multiple parallel lanes of egg contents simultaneously, thereby accommodating the multi-lane configurations commonly employed in industrial egg-breaking equipment. Each egg cup is tracked using position data derived from an encoder associated with the conveyor system, enabling precise correlation between inspection results and physical cup location.

In an embodiment, an egg inspection and selective rejection system is configured for integration with an egg-breaking machine having a conveyor transporting a plurality of cups containing egg contents, the system including a structural frame configured to be mounted to the egg-breaking machine so that at least a portion of the frame is above the conveyor. The system also includes at least one imaging device associated with the structural frame oriented to capture images of egg contents in the cups at a first inspection position. The system also includes an illumination system associated with the structural frame configured to provide controlled lighting conditions for image capture. The system also includes, an encoder coupled to the conveyor configured to generate position data corresponding to a movement of the cups. The system includes a processor operatively coupled to the imaging device and the encoder, the processor being configured to trigger image capture based on the position data such that each cup is imaged at the first inspection position, analyze each captured image using at least one machine learning model to detect a defect in the egg contents, and generate a corresponding inspection result for each cup. The system includes a position-indexed data structure configured to associate each inspection result with a corresponding cup position and a rejection actuator configured to selectively discharge egg contents from a cup based on the inspection result associated with that cup. The system includes a configuration where the processor is configured to actuate the rejection actuator in synchronization with the conveyor, such that defective egg contents are removed without stopping the conveyor.

The system may also include where the conveyor transports cups are arranged in a plurality of parallel lanes and the imaging device is configured to capture images from multiple lanes simultaneously.

The system may also include where the structural frame is configured as a retrofit module attachable to an existing egg-breaking machine without requiring structural modification of the machine.

The system may also include where the imaging device comprises at least one of an area-scan camera or a line-scan camera.

The system may also include where the illumination system includes at least one of visible, ultraviolet, or infrared light sources.

The system may also include where the machine learning model comprises a convolutional neural network trained to identify defects, including blood spots, shell fragments, or discoloration.

The system may also include where the processor is further configured to apply rule-based validation to outputs of the machine learning model to reduce false detections.

The system may also include where the position-indexed data structure comprises a first-in, first-out queue indexed by encoder position.

The system may also include where the rejection actuator comprises a pneumatic, servo-driven, or mechanical mechanism configured to tip or dump the contents of a cup.

The system may also include where the processor is configured to train or update a machine learning model using images captured during operation of the system.

The system may also include where the machine learning model is trained using labeled datasets including annotations identifying defects in egg contents.

The system may also include where the processor applies data augmentation techniques including at least one of brightness adjustment, color variation, geometric transformation, or synthetic defect insertion.

The system may also include where the processor executes a segmentation model configured to generate pixel-level identification of defects.

The system may also include where the processor combines outputs of a machine learning model with rule-based filtering to determine whether egg contents are defective.

The system may also include where the processor is configured to update defect detection thresholds based on historical inspection data.

The system may also include where the processor is configured to deploy updated machine learning models to an edge computing device without interrupting operation of the conveyor.

The system may also include where the processor is configured to process multi-spectral image data including at least one of visible, infrared, or ultraviolet image data.

The system may further comprise a centralized system configured to aggregate data from multiple inspection systems and train a shared machine learning model.

The system may also include, where the system is configured to operate without a mechanical encoder coupled to the conveyor, the processor being configured to analyze successive image frames captured by the at least one imaging device to detect individual egg cups within the field of view; track a position of each detected cup across successive frames to generate a vision-derived position index for each cup; associate each inspection result with the vision-derived position index of the corresponding cup; and actuate the rejection actuator based on the vision-derived position index to selectively discharge defective egg contents from the correct cup as the conveyor advances.

The system may also include where the processor tracks cup positions using optical flow analysis applied to successive image frames.

The system may also include where the processor tracks cup positions using template matching against a stored visual representation of a cup rim, cup cavity, or lane geometry.

The system may also include where the processor tracks cup positions using a trained object detection model configured to localize individual cups within the image frame.

The system may also include where the processor is further configured to estimate a conveyor velocity from the vision-derived position data and to adjust a rejection actuator timing signal based on the estimated velocity.

The system may also include where the system is further configured to receive encoder signals when available and to use the encoder signals to validate or calibrate the vision-derived position index.

The system may further comprise an operator quality assurance interface configured to receive operator input during operation of the conveyor, the system being further configured to receive a quality assurance input from an operator indicating that a cup at or near the inspection position has been incorrectly classified by the system; identify one or more images associated with the incorrectly classified cup based on positional data correlating the operator input to a cup position; store the identified images together with a correction label indicating the type of misclassification reported by the operator; and incorporate the stored images and correction labels into a training dataset used to update a machine learning model employed by the system.

The system may also include where the operator quality assurance interface includes a physical pushbutton accessible to an operator stationed at the egg-breaking machine.

The system may also include where the operator quality assurance interface includes a touchscreen display presenting separate input controls for reporting a false rejection and for reporting a false acceptance.

The system may also include where the correction label specifies one of a false rejection or a false acceptance, and wherein the system stores the correction label as metadata associated with the identified images.

The system may also include where the operator quality assurance interface further enables the operator to select from a predefined set of defect categories including at least one of blood spot, shell fragment, foreign material, or abnormal coloration, and wherein the selected defect category is stored as additional metadata with the identified images.

The system may also include where the processor assigns elevated sampling weights to operator-flagged images during machine learning model training to preferentially correct misclassification errors identified by the operator.

The system may also include where the processor is configured to compute and display one or more quality assurance metrics derived from operator-flagged events, including at least one of a false rejection rate or a false acceptance rate.

The system may also include where operator-flagged images and correction labels from the system are transmitted to a centralized repository and aggregated with data from one or more additional inspection systems for use in training a shared machine learning model.

In an embodiment, a method of inspecting egg contents using an egg-breaking machine having a conveyor transporting cups containing egg contents, mounting an inspection system above the conveyor to an existing egg-breaking machine; tracking positions of the cups using an encoder coupled to the conveyor; capturing images of egg contents in individual cups at a first position based on encoder-derived position data; analyzing the captured images using a processor executing a trained machine learning model to detect defects; associating each analysis result with a corresponding cup position using a position-indexed data structure; and actuating a rejection mechanism at a second position to selectively remove egg contents from cups identified as defective while the conveyor continues to move.

The method may further comprise storing captured images and associated inspection results to generate a training dataset for improving the machine learning model.

The method may further comprise applying rule-based validation to outputs of the machine learning model prior to actuating the rejection mechanism.

In an embodiment, a non-transitory computer-readable medium storing instructions that, when executed by a processor in an egg inspection system integrated with an egg-breaking machine, cause the processor to receive position data from an encoder associated with a conveyor transporting cups containing egg contents, trigger image acquisition of each cup at a predetermined inspection position, analyze each image using at least one trained machine learning model to detect a defect, store an inspection result in association with a corresponding cup position, and generate a control signal to actuate a rejection mechanism at a downstream location based on the stored inspection result.

The computer-readable medium may include where the instructions further cause the processor to update the machine learning model based on stored inspection data and deploy an updated model to the system.

In an embodiment, an egg inspection system for use with an egg-breaking machine having a conveyor transporting a plurality of cups containing egg contents in a plurality of parallel lanes, comprises a plurality of imaging devices positioned above the conveyor and arranged to collectively image egg contents in multiple parallel lanes at a common inspection region; an encoder configured to generate position data corresponding to movement of the conveyor; a synchronization controller configured to coordinate operation of the plurality of imaging devices based on the position data such that images of egg contents from the plurality of parallel lanes are captured at substantially the same relative conveyor position; a processing system configured to receive image data from the plurality of imaging devices and to analyze the image data to detect defects in egg contents for each lane; and a control interface configured to generate lane-specific inspection results corresponding to individual cups in each of the plurality of parallel lanes, wherein the synchronization controller and the processing system cooperate to maintain temporal and positional alignment of inspection results across the plurality of parallel lanes to enable downstream selective rejection of defective egg contents in real-time.

The system may also include where the plurality of imaging devices are arranged such that each imaging device is dedicated to a corresponding lane.

The system may include where at least one imaging device is configured to capture images spanning multiple lanes within a single field of view.

The system may include where the synchronization controller is configured to trigger all imaging devices within a predefined timing tolerance relative to the encoder position.

In an embodiment, a non-transitory computer-readable medium storing instructions that, when executed by a processor, cause a processor to receive images of egg contents; analyze the images using a trained machine learning model to detect defects; associate detection results with conveyor positions; and generate control signals to actuate a rejection mechanism.

The system may further comprise an illumination system configured to provide uniform lighting across the plurality of parallel lanes.

### BRIEF DESCRIPTION OF THE DRAWINGS

FIG. 1 is a schematic-type perspective view of a multi-lane egg-breaker conveyor passing beneath the inspection system of the disclosure;

FIG. 2 is a block diagram of hardware architecture (cameras, illumination, trigger/encoder, industrial computer, reject actuator, database);

FIG. 3 illustrates a method 200 of image acquisition, analysis, and rejection control, including image acquisition 210, preprocessing 220, defect detection 230, defect classification 240, decision logic 250, data storage 260, rejection logic 270, and actuation of a rejection actuator 280; and

FIG. 4 is a block diagram of an embodiment of the system of the disclosure, illustrating PLC & hardware control, vision system, and vision hardware.

### DETAILED DESCRIPTION OF THE DISCLOSURE

The present disclosure will now be described in detail with reference to illustrative embodiments. It should be understood that these embodiments are provided by way of example and are not intended to limit the scope of the disclosure. The present disclosure provides a vision-based inspection system configured to operate in conjunction with an existing egg-breaking machine. The system is designed as a retrofit module that may be mounted above the conveyor portion of the egg-breaking machine, thereby allowing integration with minimal or no modification of the underlying equipment.

In an embodiment, the system mounts directly over the cups or troughs of an automatic egg‑breaker machine and provides 100 % real‑time inspection of liquid yolk and albumen. Major functional elements include: a multi‑row imaging station that captures high‑resolution images of every broken egg using area or line‑scan CMOS cameras; a spectrally‑tailored illumination (visible, NIR, UV, or multispectral) that accentuates the contrast of the targeted defects; an edge‑AI processing computer executing deterministic computer‑vision (CV) algorithms and convolutional neural‑network (CNN) classifiers, delivering pass/fail results within the breaker cycle time; a servo or pneumatic rejector that diverts or dumps defective eggs on a per‑cup basis without reducing throughput; and a system for data logging that archives every inspected image with meta‑data for traceability and continuous model improvement; and where the system may accommodate breaker layouts in which yolk and white are collected either in the same cup or in separate adjacent cups, and scales to multiple production lanes.

In an embodiment, a stainless steel enclosure possessing IP69K wash-down compliance is mounted over the conveyor frame of a commercial automatic egg breaker. Multiple lanes of breaker cups proceed beneath the enclosure. LED light arrays provide diffuse, uniform lighting; optional UV emitters enhance fluorescence signatures associated with microbial spoilage. A glass window separates the food zone from the electronics.

When a breaker variant separates yolk and albumen into two distinct cups, both cups remain within the depth of field of the downward-facing camera; the processing algorithm may therefore evaluate each liquid component independently and combine the results.

Synchronized triggers from a shaft encoder ensure each camera exposure occurs at a repeatable cup position. Digitized frames stream over a standard interface to a computer.

The processing steps include classical CV (edge-based shell fragment detection, blob analysis for foreign particles) and/or a CNN trained on a large dataset of annotated images representing blood spots, rot, cloudiness gradients, and more.

A high-speed pneumatic gate or tilting chute (location varies by breaker model) responds to the verdict within T ms (a predetermined response interval), ejecting non-edible eggs while allowing good product to proceed to pooling tanks.

In an embodiment, hyperspectral cameras are used to extract chemical information (e.g., glucose or pH variation).

It should be appreciated that the disclosure has application to other food liquids (tomato processing, fruit pulp) in where contaminants appear only after maceration.

In an embodiment, the system may be integrated with upstream robotic loaders to bypass cracked shell lanes.

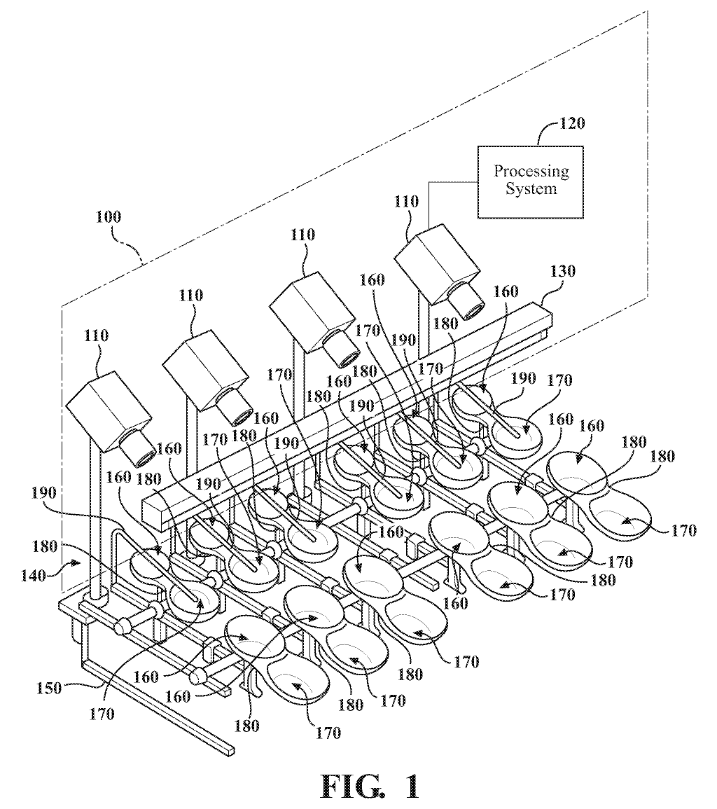

In a representative embodiment, the system is configured as a modular inspection unit that is mounted above the conveyor of an existing egg-breaking machine. The egg-breaking machine cracks eggs and deposits their contents into individual cups that are transported along a conveyor in multiple parallel lanes. As shown in FIG. 1, several rows of egg cups pass beneath a set of cameras and lighting elements positioned above the conveyor.

The inspection module includes a structural frame that supports the imaging and illumination components and is configured to be attached to the existing machinery without requiring any significant modifications to the underlying egg-breaking system. The frame is preferably constructed of materials suitable for food processing environments, such as stainless steel, and may be designed to meet washdown requirements. The module may include a sealed enclosure with optical windows that allow imaging while protecting internal electronics from contamination.

In a typical embodiment, eggs are cracked by mechanical breaker elements, and the contents of each egg, including yolk and albumen, are deposited into individual cups that are arranged along a continuously moving conveyor. Each cup serves as an individual inspection unit. The inspection system includes a frame or enclosure that is mounted above the conveyor, such that the egg contents within each cup are visible to the imaging system as the cups pass through an inspection region.

The frame may be constructed from materials suitable for food processing environments, such as stainless steel, and may be configured to meet washdown requirements. The enclosure may include optical windows that allow imaging while protecting internal components from contamination. The system may be mounted using brackets, supports, or other attachment mechanisms that enable installation onto existing machinery.

The system includes one or more imaging devices positioned to capture images of egg contents within the cups. In an embodiment, cameras are oriented toward the egg contents contained within the cups. These cameras may be area-scan or line-scan imaging devices and are positioned to capture images of one or more lanes of egg contents simultaneously. In multi-lane configurations, a plurality of cameras may be used, or a single camera with a sufficiently wide field of view may be employed.

An illumination system is provided to ensure consistent and controlled lighting conditions. The illumination system may include light-emitting diode (LED) arrays configured to provide lighting, as well as optional ultraviolet or near-infrared lighting to enhance contrast of certain defects. The lighting arrangement may be optimized to minimize reflections and shadows and to improve visibility of features within the egg contents.

Accurate inspection requires precise synchronization between image capture and the position of each egg cup. To achieve this, the system includes an encoder that is mechanically coupled to the conveyor or to a drive component of the egg-breaking machine. The encoder generates signals corresponding to the position of the conveyor, allowing the system to determine when each cup reaches a predefined inspection location.

In an embodiment, when a cup reaches the inspection position, the system triggers the camera to capture an image. Each captured image is associated with positional data, including encoder counts and a cup index, enabling the system to track each cup as it moves through the inspection and rejection stages.

In order to ensure accurate inspection of each cup, the system is configured to synchronize image acquisition with the position of the cups on the conveyor. A rotary encoder or similar position-sensing device is coupled to the conveyor or to a drive component of the egg-breaking machine. The encoder generates signals corresponding to the position of the conveyor, allowing the system to determine when each cup reaches a predefined inspection location.

When a cup reaches the inspection position, the system triggers the imaging device to capture an image of the egg cup. An image processing algorithm is used to precisely locate egg contents within that cup. Each captured image is associated with positional data, including encoder counts and cup index, thereby enabling precise tracking of each cup throughout the inspection and rejection process.

Captured images are transmitted to a processing unit, which may include an industrial computer or edge computing device. The processing unit executes image analysis algorithms that identify defects within the egg contents. These algorithms may include both traditional computer vision techniques and machine learning-based approaches. In some embodiments, the processing includes preprocessing steps such as normalization, filtering, and feature extraction.

In some embodiments, the processing pipeline includes preprocessing steps that normalize the image data and reduce noise. The system may then apply feature extraction and classification techniques to determine whether the egg contents are acceptable or defective. Defects that may be detected include blood spots, shell fragments, discoloration, foreign materials, and abnormalities in yolk structure.

The system may employ a hybrid decision-making approach in which the outputs of machine learning models are validated using deterministic rules. For example, a region identified as a potential defect by a neural network may be further evaluated based on size, color, or shape criteria to reduce false detections.

Defect detection may be performed using machine learning models, such as convolutional neural networks, that are trained to recognize patterns associated with defects. The system may also employ rule-based logic to validate or refine the outputs of the machine learning models. For example, detected regions may be evaluated based on size, color, or shape criteria to reduce false detections.

The processing unit generates a pass/fail determination for each cup, and may also classify the type of defect detected.

Following analysis, the system generates a pass or fail determination for each cup. These determinations are stored in a data structure that associates each result with the corresponding cup position. This association allows the system to track each cup as it moves from the inspection location to a downstream rejection location.

In one embodiment, the system maintains a first-in, first-out queue indexed by encoder position. As each cup reaches the rejection location, the system retrieves the corresponding inspection result and determines whether the cup should be rejected.

The system includes a rejection mechanism in proximity to the inspection region or positioned downstream of it. When a cup identified as defective reaches the rejection location, the system actuates the rejection mechanism to remove the egg contents from the cup. This may be accomplished through a pneumatic actuator, a servo-driven mechanism, or a mechanical tipping device that causes the contents of the cup to be discharged.

The rejection mechanism operates in synchronization with the conveyor and does not require interruption of the processing line, thereby allowing the system to maintain high throughput and real-time processing.

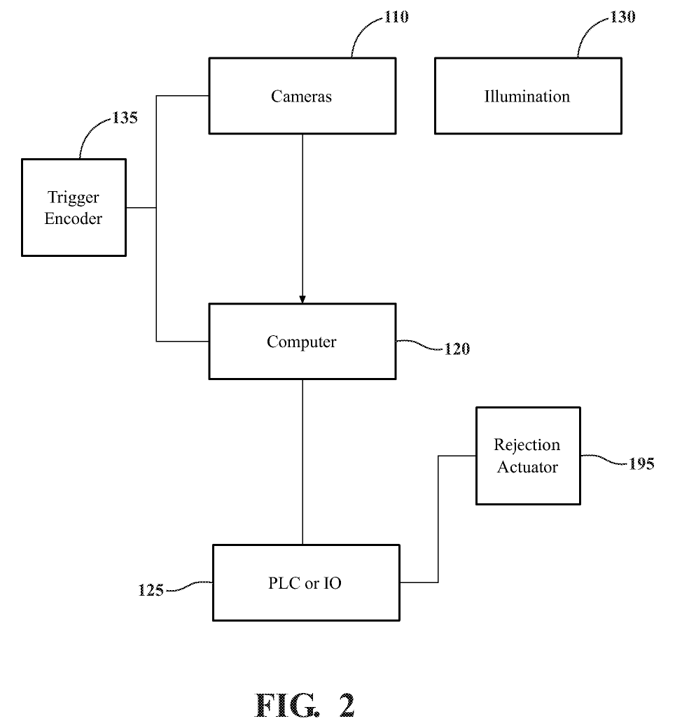

Referring now to FIGS. 1 and 2, an integrated egg inspection and rejection system 100 of a non-limiting embodiment of the disclosure, are illustrated and include cameras 110 in operational communication with a processing system 120 and an illumination system 130. The control system 120 includes processing hardware and software and may communicate with other computing resources. As shown in FIG. 2, the integrated egg inspection and rejection system 100 includes a computer 120 in operational communication with one or more cameras 110, a programmable logic controller (PLC) or input/output interface 125, a trigger and encoder 130, an illumination system 135, and a rejection actuator 195. The rejection actuator 195 is configured to receive control signals from the computer 120 and to selectively discharge defective egg contents from individual cups 180 in response thereto. The hardware architecture illustrated in FIG. 2 represents a representative embodiment; the specific components and communication interfaces may vary depending on the installation environment and the configuration of the underlying egg-breaking machine. The hardware and software may be well known to persons of skill in the art and may include addition resources as described in various embodiments of this disclosure. The inspection and rejection system 100 includes a structural frame 140 that supports the imaging and illumination components. The frame 140 is configured to be mounted above an egg-processing conveyor 150 and may be secured to existing equipment or support structures. The frame 140 houses and protects the internal components of the inspection module and provides proper alignment of the imaging system relative to the egg contents.

One or more of the cameras 110 are mounted to the frame 140 of the inspection module and are oriented downward toward egg contents, including the yolk 160 and albumen 170 contained within cups 180 traveling along the conveyor 150. The cameras 110 are configured to capture images of the egg contents (160, 170) of the cups 180 at predetermined inspection positions. The cameras 110 may include high-resolution industrial imaging devices capable of detecting fine defects within the egg contents.

The illumination system 130 may include more than one illumination unit positioned adjacent to the cameras 110 and configured to illuminate the egg contents (160, 170) to enhance visibility of defects. The illumination system 130 may include one or more light sources, such as LED arrays, and may provide diffuse, directional, or multi-spectral lighting depending on the inspection requirements.

An egg-breaking unit (not shown) is positioned upstream of the inspection system 100 and is configured to crack eggs and deposit the egg contents (160, 170) into individual cups 180. The egg-breaking unit may include mechanical cracking elements that open the egg shells and direct the contents into the cups 180. It is intended that the egg inspection and rejection system 100 be integrated into existing egg processing systems used to crack eggs and allow inspection and rejection of the egg contents. This allows for adding an important improvement to existing well-developed technology. The existing systems typically have a manually operated lever 190 for actuating when bad egg contents are detected by a person assigned to inspect the contents. Advantageously, the egg inspection and rejection system 100 includes an actuator 195 configured to actuate the lever 190 when it detects bad egg contents.

The existing systems further include a processing conveyor 150 to carry a plurality of the egg cups 180, each cup configured to receive and transport the contents of a single egg (160, 170). The egg cups 180 are arranged in sequence along the conveyor and move through the inspection region beneath the inspection module. Each egg cup 180 serves as an individual inspection container.

The control system 120 of the integrated egg inspection and rejection system 100 includes an encoder 135 associated with the conveyor system and is configured to provide position data corresponding to the movement of the egg cups 180. The encoder 135 generates signals that allow the system 100 to determine when each egg cup 180 reaches a predetermined inspection position and a downstream rejection position.

A programmable logic controller (PLC) 315 configured to control the rejection actuator 195 is configured to selectively signal the removal of defective egg contents from the egg cups 180. The rejection actuator 195 may include a mechanical, pneumatic, or electromechanical actuator configured to actuate the tilting, dumping, or otherwise emptying of the contents of selected egg cup 180, identified as defective.

An eject chute (not shown) is positioned downstream and is configured to receive and direct rejected egg contents away from the conveyor system. The eject chute ensures that defective contents are removed from the processing line in a controlled manner.

During operation, egg contents are deposited into the egg cups 180 by the egg-breaking unit, and the cups are transported along the conveyor. The encoder tracks positional feedback that enables the cameras 110 to capture images of each egg cup at the appropriate inspection location. The captured images are analyzed to determine whether the egg contents are defective. If a defect is detected, the rejection mechanism is actuated when the corresponding egg cup reaches the rejection location, thereby causing the contents of that cup to be discharged into the eject chute.

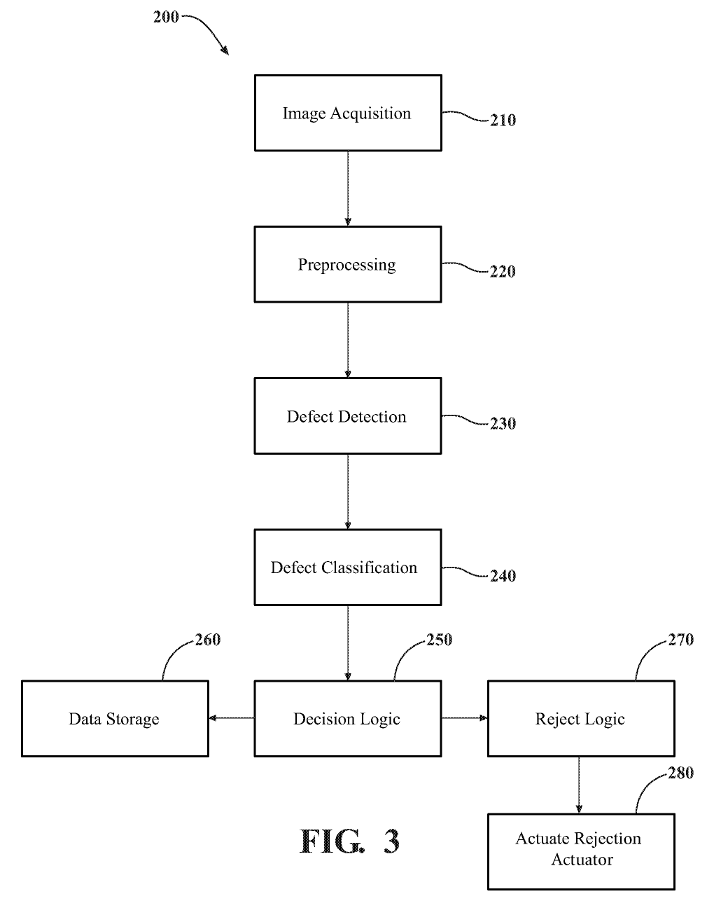

With added reference to FIG. 3, a method 200 of the system 100 includes acquiring images 210 from the cameras 110, preprocessing 220 of the image and location data for each of the egg cups 180, detecting defects 230 in the egg contents (160, 170), classifying the defects 240 based on stored images, and in an embodiment machine learning, applying decision logic 250 to the defect analysis which includes storing data 260 based on the decision algorithm. The classifying the defects 240 includes applying rejection logic 270 to determine if the egg contents (160, 170) should be rejected, and if rejection is determined, then actuating 280 the rejection actuator 195.

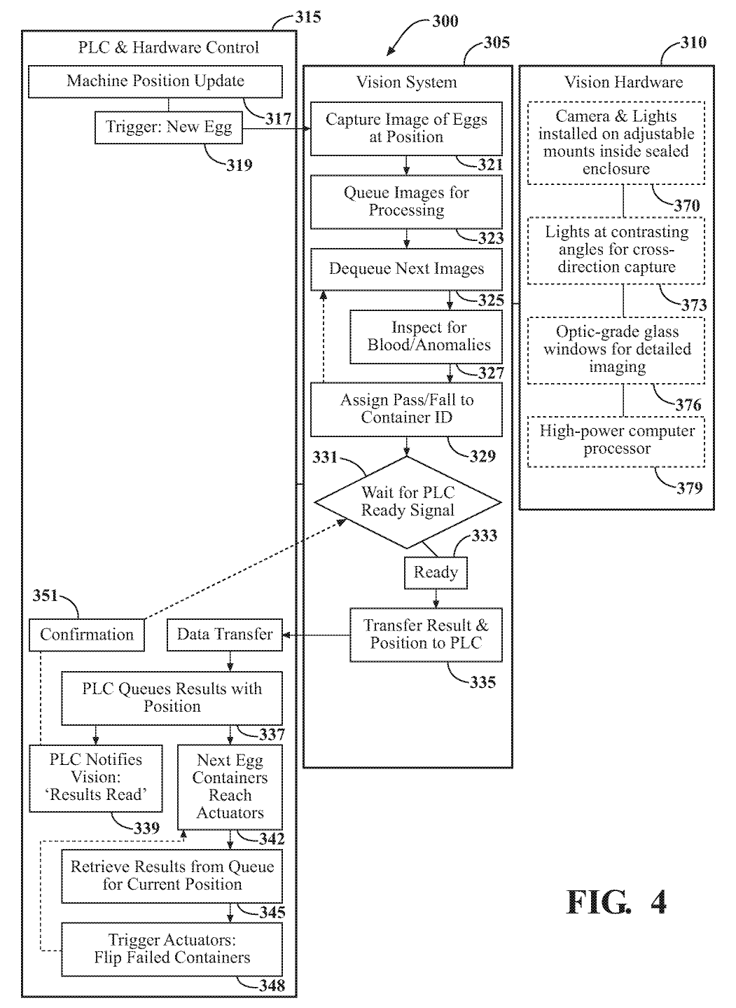

With added reference to FIG. 4, in an embodiment of the egg contents inspection system 300, a vision system 305, including vision hardware 310, is in operational communication with a PLC and hardware control system 315. The PLC 315 monitors the conveyor machine location 317 which may trigger the presence of a new egg 319. The vision system 305 is then activated to capture images of the eggs contents at their position 321. Images are queued for processing 323. Depending on the results of the images, the next images may be dequeued 325. The images are inspected for blood or other abnormalities 327. Each container is assigned a pass or fail 329. The system waits for a PLC ready signal 331 and when ready 333, transfers the results and egg position 335 to the PLC. The PLC queues the results with the position of the eggs 337. The PLC notifies the vision system that the results have been read 339 and the PLC signals that the next egg containers have reached the actuators 342. Results are retrieved from the queue for the current position 345, and based on the results, the actuator may be triggered 348 to dump the egg contents. The system includes a confirmation 351.

The vision hardware 310 may include cameras and lights mounted inside a sealed enclosure 370 which prevents potential contamination of the eggs. Lights 373 are positioned at contrasting angles for cross-direction capture. The vision hardware 310 may include optic-grade glass windows 376 for allowing detailed imaging. The vision hardware 310 may also be controlled by a high-power computer processor 379.

In certain embodiments, the processing system 120 further includes a data acquisition and training pipeline configured to generate, maintain, and improve one or more machine learning models used to detect defects in egg contents. The system is configured to capture images of egg contents during normal operation and to associate each image with corresponding metadata, including encoder position, cup index, timestamp, lighting configuration, and an inspection result. These images and associated metadata may be stored locally within the system or transmitted to a centralized storage system for further processing.

In one embodiment, the system is configured to generate labeled datasets for training machine learning models. Labeling of captured images may be performed manually by trained operators who identify defects present in the images, or may be performed using semi-automated techniques in which initial classifications generated by the system are reviewed and corrected. In further embodiments, labeling may be performed using active learning techniques, wherein images for which the system has low confidence in its classification are automatically flagged for human review. The labeled data may include classifications indicating the presence or absence of defects such as blood spots, shell fragments, foreign contaminants, abnormal coloration, or yolk rupture. In some embodiments, the labeled data may further include pixel-level annotations defining the precise spatial extent of defects within the image.

Prior to training, the captured image data may be subjected to preprocessing operations designed to normalize the data and improve model performance. Such preprocessing may include normalization of brightness and contrast to account for variations in illumination, correction for glare or reflections caused by liquid surfaces, geometric alignment of images based on known cup positions, and removal of background noise. In addition, the system may apply data augmentation techniques to expand the effective size and diversity of the training dataset. These augmentation techniques may include controlled variations in brightness, contrast, and color; geometric transformations such as rotation, translation, or scaling; and the synthetic insertion of simulated defects to improve the model’s ability to recognize rare or subtle defect conditions.

The machine learning models employed by the system may include one or more of classification models, object detection models, segmentation models, and anomaly detection models. In one embodiment, a classification model is trained to determine whether egg contents are acceptable or defective. In another embodiment, an object detection model is trained to identify and localize specific defects within an image, providing bounding box coordinates and associated confidence scores. In a further embodiment, a segmentation model is trained to perform pixel-wise classification of the image, thereby identifying the precise shape and extent of defects within the egg contents. In other implementations such as anomaly detection, the system may use only images of defect free egg content to train a model. In certain implementations, the system may employ a hybrid architecture in which a segmentation model is first used to identify candidate defect regions, and a classification model is subsequently used to evaluate the severity or type of defect.

Training of the machine learning models may be performed using supervised learning techniques in which labeled datasets are used to optimize model parameters. The training process may employ loss functions appropriate to the task, including cross-entropy loss for classification tasks and intersection-over-union or Dice loss for segmentation tasks. In order to address class imbalance, particularly in cases where defects occur infrequently relative to acceptable egg contents, weighted loss functions or sampling strategies may be employed. The dataset may be partitioned into training, validation, and testing subsets to evaluate model performance and prevent overfitting. Performance metrics may include precision, recall, false reject rate, false accept rate, and inference latency, with particular emphasis on maintaining performance within the time constraints imposed by the conveyor cycle.

Once trained, the machine learning models are deployed to an edge computing device associated with the inspection system. The edge computing device may include specialized hardware such as a graphics processing unit, tensor processing unit, field-programmable gate array, or other hardware accelerator configured to execute machine learning inference operations. In order to meet real-time processing requirements, the models may be optimized using techniques such as quantization, pruning, and pipeline parallelization. The deployed system is configured to generate inspection results within a deterministic time window that ensures proper synchronization with the encoder-based tracking of egg cups.

In an alternative embodiment, the inspection system is configured to operate without a mechanical encoder coupled to the conveyor. In this encoder-free mode, the system derives cup position and conveyor velocity information directly from image data captured by one or more imaging devices, thereby eliminating the need for a separate position-sensing hardware component.

In one implementation of this embodiment, the processor is configured to analyze successive image frames captured at a fixed frame rate to detect and track the positions of individual egg cups. The processor may employ one or more computer vision techniques to accomplish this tracking, including but not limited to: optical flow analysis, which estimates the motion vectors of pixels or image regions between frames; template matching, in which the visual appearance of a cup rim, cup cavity, or characteristic geometric feature of the cup is matched against each incoming frame to localize the cup; or object detection models trained to identify cup boundaries, lanes, and individual cup instances within the field of view.

The processor maintains a vision-derived position index for each cup, updating the index as each cup traverses the inspection region. This vision-derived position index serves the same functional role as the encoder-derived position data described in other embodiments: it enables the system to associate each inspection result with a specific cup, to predict when each cup will reach the rejection mechanism, and to actuate the rejection mechanism with the timing precision required to selectively discharge defective egg contents without interrupting conveyor motion.

In some implementations, the system may operate in a hybrid mode in which vision-based cup tracking serves as a primary or supplementary source of position data, with encoder signals, if available, used as a secondary reference for calibration or validation. In other implementations, the vision-based tracking operates as the sole source of positional information.

The encoder-free embodiment facilitates installation of the inspection system on egg-breaking machines that do not provide accessible encoder outputs or that use conveyor drive configurations incompatible with mechanical encoder coupling. By relying solely on image-derived position data, the system reduces the number of hardware integration points required during installation, thereby enabling broader compatibility with existing egg-processing equipment and lowering the cost and complexity of retrofit deployment.

In certain embodiments, the system employs a hybrid decision-making framework in which outputs of the machine learning model are combined with rule-based validation. For example, the machine learning model may identify a candidate defect region and assign a confidence score, and the system may apply deterministic rules to verify that the detected region satisfies predefined criteria such as minimum size, color characteristics, or spatial consistency. This combination of machine learning and rule-based processing improves reliability and reduces the likelihood of false positive or false negative determinations in industrial environments.

The system may further include a continuous learning mechanism that enables ongoing improvement of the machine learning models. During operation, images and corresponding inspection results may be monitored to identify cases in which the system’s predictions are incorrect or uncertain. These cases may be flagged for review and incorporated into updated training datasets. Updated models may be trained periodically, either locally or in a centralized computing environment, and subsequently deployed to the inspection system. In some embodiments, model updates are managed using version control and are deployed in a manner that does not interrupt the operation of the egg-processing line.

In a further embodiment, the system includes an operator quality assurance interface that enables a human operator to identify and report inspection errors in real time during normal production. This interface provides a mechanism by which the operator can flag individual egg cups as having been incorrectly classified by the automated inspection system, thereby generating labeled correction data that is automatically incorporated into a model improvement pipeline.

The operator quality assurance interface includes one or more input elements that the operator may activate during production. In one implementation, the interface includes a dedicated physical pushbutton mounted in a location accessible to the operator stationed at or near the egg-breaking machine. In another implementation, the interface includes a touchscreen control displayed on a monitor associated with the inspection system. The interface may present separate input elements for reporting a false rejection, in which defect-free egg contents were incorrectly discharged by the rejection mechanism, and for reporting a false acceptance, in which defective egg contents were incorrectly passed as acceptable.

When the operator activates an input element, the system identifies the egg cup or cups that were at or near the inspection position at the moment of activation. The system uses encoder-derived or vision-derived position data to correlate the operator’s input with the relevant cup position, lane, and inspection timestamp. The system retrieves the one or more images captured of the identified cup and associates them with a correction label indicating the type of error reported by the operator.

The retrieved images and associated correction labels are stored in a designated training data repository. Metadata recorded with each operator-flagged sample may include the timestamp of flagging, the cup position index, the lane identifier, the inspection result originally generated by the system, the operator-assigned correction label, and the type of defect reported if applicable. In some implementations, the operator may also select from a predefined menu of defect categories, such as blood spot, shell fragment, or abnormal coloration, to provide additional specificity.

The operator-flagged samples are incorporated into the model retraining pipeline described herein. In one embodiment, these samples are periodically aggregated with other training data and used to retrain or fine-tune the machine learning model. In another embodiment, the system applies active learning techniques in which operator-flagged samples, by virtue of representing confirmed model errors, are assigned elevated sampling weights during training to disproportionately correct the types of misclassifications most frequently encountered in operation.

In some embodiments, the system tracks quality assurance metrics derived from operator-flagged events. These metrics may include a false rejection rate, calculated as the number of operator-reported false rejections per unit time or per number of eggs processed; a false acceptance rate, calculated analogously; and a cumulative correction count segmented by defect type. These metrics may be displayed on the operator interface and may be used to trigger automatic threshold adjustments or to prioritize the scheduling of model retraining cycles.

In further embodiments, operator-flagged data collected across multiple inspection system installations may be aggregated in a centralized repository and used to train shared machine learning models, as described in connection with enterprise-level model aggregation. In such embodiments, operator corrections from different facilities collectively contribute to a continuously improving shared model that benefits all installations.

In addition, the system may implement adaptive thresholding and self-calibration features. The system may dynamically adjust decision thresholds based on historical inspection data, environmental conditions, or machine-specific characteristics. For example, the system may periodically capture reference images of known acceptable egg contents and adjust normalization parameters or lighting settings to maintain consistent detection performance. These calibration routines may be performed automatically or in response to operator input.

In further embodiments, the system may utilize multi-modal or multi-spectral imaging data to improve defect detection. The system may capture images in multiple spectral bands, including visible, near-infrared, and ultraviolet wavelengths, and may combine these inputs to enhance the visibility of certain types of defects. The machine learning models may be trained to process such multi-modal inputs and to generate defect classifications based on fused information from multiple spectral sources.

In still further embodiments, the system may be deployed across multiple facilities, and a centralized learning system may aggregate data collected from multiple inspection systems. The aggregated data may be used to train generalized machine learning models that are robust across different operating conditions, and the trained models may be distributed back to individual inspection systems. This distributed learning approach enables continuous improvement of defect detection performance across a fleet of machines.

In some embodiments, the system may use an image library and/or a pretrained model without requiring training on the installation-specific system.

Several embodiments have been discussed in the foregoing description. However, the embodiments discussed herein are not intended to be exhaustive or limit the disclosure to any particular form. The terminology which has been used is intended to be in the nature of words of description rather than of limitation. All the disclosed embodiments are intended to be non-limiting embodiments. Many modifications and variations are possible in light of the above teachings, and the invention may be practiced otherwise than as specifically described.

What is claimed is:

1. An egg inspection and selective rejection system configured for integration with an egg-breaking machine having a conveyor transporting a plurality of cups containing egg contents, the system comprising:
a structural frame configured to be mounted to the egg-breaking machine so that at least a portion of the frame is above the conveyor;
at least one imaging device associated with the structural frame oriented to capture images of egg contents in the cups at a first inspection position;
an illumination system associated with the structural frame configured to provide controlled lighting conditions for image capture;
an encoder coupled to the conveyor configured to generate position data corresponding to a movement of the cups;
a processor operatively coupled to the imaging device and the encoder, the processor being configured to trigger image capture based on the position data such that each cup is imaged at the first inspection position, analyze each captured image using at least one machine learning model to detect a defect in the egg contents, and generate a corresponding inspection result for each cup;
a position-indexed data structure configured to associate each inspection result with a corresponding cup position; and
a rejection actuator configured to selectively discharge egg contents from a cup based on the inspection result associated with that cup,
wherein the processor is configured to direct actuation of the rejection actuator in synchronization with the conveyor such that defective egg contents are removed without stopping the conveyor.

2. The system of claim 1, wherein the cups transported by the conveyor are arranged in a plurality of parallel lanes, and the imaging device is configured to capture images from multiple lanes simultaneously.

3. The system of claim 1, wherein the structural frame is configured as a retrofit module attachable to an existing egg-breaking machine without requiring structural modification of the machine.

4. The system of claim 1, wherein the imaging device comprises at least one of an area-scan camera or a line-scan camera.

5. The system of claim 1, wherein the illumination system includes at least one of visible, ultraviolet, or infrared light sources.

6. The system of claim 1, wherein the machine learning model comprises a convolutional neural network trained to identify defects, including blood spots, shell fragments, or discoloration.

7. The system of claim 1, wherein the processor is further configured to apply rule-based validation to outputs of the machine learning model to reduce false detections.

8. The system of claim 1, wherein the position-indexed data structure comprises a first-in, first-out queue indexed by encoder position.

9. The system of claim 1, wherein the rejection actuator comprises a pneumatic, servo-driven, or mechanical mechanism configured to tip or dump the contents of a cup.

10. The system of claim 1, wherein the processor is configured to train or update a machine learning model using images captured during operation of the system.

11. The system of claim 10, wherein the machine learning model is trained using labeled datasets including annotations identifying defects in egg contents.

12. The system of claim 10, wherein the processor applies data augmentation techniques including at least one of brightness adjustment, color variation, geometric transformation, or synthetic defect insertion.

13. The system of claim 1, wherein the processor executes a segmentation model configured to generate pixel-level identification of defects.

14. The system of claim 1, wherein the processor combines outputs of a machine learning model with rule-based filtering to determine whether egg contents are defective.

15. The system of claim 1, wherein the processor is configured to update defect detection thresholds based on historical inspection data.

16. The system of claim 1, wherein the processor is configured to deploy updated machine learning models to an edge computing device without interrupting operation of the conveyor.

17. The system of claim 1, wherein the processor is configured to process multi-spectral image data including at least one of visible, infrared, or ultraviolet image data.

18. The system of claim 1, further comprising a centralized system configured to aggregate data from multiple inspection systems and train a shared machine learning model.

19. An egg inspection and selective rejection system configured for integration with an egg-breaking machine having a conveyor transporting a plurality of cups containing egg contents, the system comprising:
a structural frame configured to be mounted to the egg-breaking machine so that at least a portion of the frame is above the conveyor;
at least one imaging device associated with the structural frame oriented to capture images of egg contents in the cups at a first inspection position;
an illumination system associated with the structural frame configured to provide controlled lighting conditions for image capture;
a processor operatively coupled to the imaging device and configured to analyze successive image frames captured by the at least one imaging device to detect individual egg cups within the field of view; track a position of each detected cup across successive frames to generate a vision-derived position index for each cup; associate each inspection result with the vision-derived position index of the corresponding cup; and actuate a rejection actuator based on the vision-derived position index to selectively discharge defective egg contents from the correct cup as the conveyor advances;
a position-indexed data structure configured to associate each inspection result with a corresponding cup position; and
a rejection actuator configured to selectively discharge egg contents from a cup based on the inspection result associated with that cup, wherein the processor is configured to actuate the rejection actuator in synchronization with the conveyor such that defective egg contents are removed without stopping the conveyor.

20. The system of claim 19, wherein the processor tracks cup positions using optical flow analysis applied to successive image frames.

21. The system of claim 19, wherein the processor tracks cup positions using template matching against a stored visual representation of a cup rim, cup cavity, or lane geometry.

22. The system of claim 19, wherein the processor tracks cup positions using a trained object detection model configured to localize individual cups within the image frame.

23. The system of claim 19, wherein the processor is further configured to estimate a conveyor velocity from the vision-derived position data and to adjust a rejection actuator timing signal based on the estimated velocity.

24. The system of claim 19, wherein the system is further configured to receive encoder signals when available and to use the encoder signals to validate or calibrate the vision-derived position index.

25. The system of claim 1, further comprising an operator quality assurance interface configured to receive operator input during operation of the conveyor, the system being further configured to:
receive a quality assurance input from an operator indicating that a cup at the inspection position or within a predefined number of cup positions thereof has been incorrectly classified by the system;
identify one or more images associated with the incorrectly classified cup based on positional data correlating the operator input to a cup position;
store the identified images together with a correction label indicating the type of misclassification reported by the operator; and
incorporate the stored images and correction labels into a training dataset used to update a machine learning model employed by the system.

26. The system of claim 25, wherein the operator quality assurance interface includes a physical pushbutton accessible to an operator stationed at the egg-breaking machine.

27. The system of claim 25, wherein the operator quality assurance interface includes a touchscreen display presenting separate input controls for reporting a false rejection and for reporting a false acceptance.

28. The system of claim 25, wherein the correction label specifies one of a false rejection or a false acceptance, and wherein the system stores the correction label as metadata associated with the identified images.

29. The system of claim 25, wherein the operator quality assurance interface further enables the operator to select from a predefined set of defect categories including at least one of blood spot, shell fragment, foreign material, or abnormal coloration, and wherein the selected defect category is stored as additional metadata with the identified images.

30. The system of claim 25, wherein the processor assigns elevated sampling weights to operator-flagged images during machine learning model training to preferentially correct misclassification errors identified by the operator.

31. The system of claim 25, wherein the processor is configured to compute and display one or more quality assurance metrics derived from operator-flagged events, including at least one of a false rejection rate or a false acceptance rate.

32. The system of claim 25, wherein operator-flagged images and correction labels from the system are transmitted to a centralized repository and aggregated with data from one or more additional inspection systems for use in training a shared machine learning model.

33. A method of inspecting egg contents in an egg-breaking machine having a conveyor transporting cups containing egg contents, the method comprising:
mounting an inspection system above the conveyor to an existing egg-breaking machine;
tracking positions of the cups using an encoder coupled to the conveyor;
capturing images of egg contents in individual cups at a first position based on encoder-derived position data;
analyzing the captured images using a processor executing a trained machine learning model to detect defects;
associating each analysis result with a corresponding cup position using a position-indexed data structure; and
actuating a rejection mechanism to selectively remove egg contents from cups identified as defective while the conveyor continues to move.

34. The method of claim 33, further comprising storing captured images and associated inspection results to generate a training dataset for improving the machine learning model.

35. The method of claim 33, further comprising applying rule-based validation to outputs of the machine learning model prior to actuating the rejection mechanism.

36. A non-transitory computer-readable medium storing instructions that, when executed by a processor in an egg inspection system integrated with an egg-breaking machine, cause the processor to receive position data from an encoder associated with a conveyor transporting cups containing egg contents, trigger image acquisition of each cup at a predetermined inspection position, analyze each image using at least one trained machine learning model to detect a defect, store an inspection result in association with a corresponding cup position, and generate a control signal to actuate a rejection mechanism based on the stored inspection result.

37. The computer-readable medium of claim 36, wherein the instructions further cause the processor to update the machine learning model based on stored inspection data and deploy an updated model to the system.

38. An egg inspection system for use with an egg-breaking machine having a conveyor transporting a plurality of cups containing egg contents in a plurality of parallel lanes, the system comprising:
a plurality of imaging devices positioned above the conveyor and arranged to collectively image egg contents in multiple parallel lanes at a common inspection region;
an encoder configured to generate position data corresponding to movement of the conveyor;
a synchronization controller configured to coordinate operation of the plurality of imaging devices based on the position data such that images of egg contents from the plurality of parallel lanes are captured at substantially the same relative conveyor position;
a processing system configured to receive image data from the plurality of imaging devices and to analyze the image data to detect defects in egg contents for each lane; and
a control interface configured to generate lane-specific inspection results corresponding to individual cups in each of the plurality of parallel lanes, wherein the synchronization controller and the processing system cooperate to maintain temporal and positional alignment of inspection results across the plurality of parallel lanes to enable a downstream rejection mechanism to selectively discharge defective egg contents in real-time.

39. The system of claim 38, wherein the plurality of imaging devices are arranged such that each imaging device is dedicated to a corresponding lane.

40. The system of claim 38, wherein at least one imaging device is configured to capture images spanning multiple lanes within a single field of view.

41. The system of claim 38, wherein the synchronization controller is configured to trigger all imaging devices within a predefined timing tolerance relative to the encoder position.

42. The system of claim 38, further comprising an illumination system configured to provide uniform lighting across the plurality of parallel lanes.

43. A non-transitory computer-readable medium storing instructions that, when executed by a processor, cause the processor to:
receive images of egg contents;
analyze the images using a trained machine learning model to detect defects;
associate detection results with conveyor positions; and
generate control signals to actuate a rejection mechanism.
